(19) United States
(12) Patent Application Publication
(10) Pub. No.: US 2013/0047564 A1
(43) Pub. Date: Feb. 28, 2013

(54) Exhaust Gas After-Treatment Device With Pressurized Shielding

(71) Applicants: James M. Hershbarger, LeClaire, IA (US); James P. Batzold, Davenport, IA (US)

(72) Inventors: James M. Hershbarger, LeClaire, IA (US); James P. Batzold, Davenport, IA (US)

(21) Appl. No.: 13/219,642

(22) Filed: Aug. 27, 2011

(51) Int. Cl. B01D 50/00

(52) U.S. Cl. 55/385.7

(57) ABSTRACT

An exhaust gas after-treatment device has a body containing an after-treatment element and a shield that substantially encloses the outer surface of the after-treatment device. The shield is coupled to the exhaust gas outlet of the after-treatment device such that at least a portion of the exhaust gas exiting the after-treatment device is conducted into the space between the outer surface of the after-treatment device and the shield.

### FIELD OF THE INVENTION

The present invention relates to after-treatment devices for internal combustion engines. More particularly it relates to devices for keeping after-treatment devices clean. Even more particularly, it relates to pressurized shielding for after-treatment devices.

### BACKGROUND OF THE INVENTION

Agricultural equipment operates in dusty, dirty environments full of light fluffy dry crop material. This equipment is traditionally powered with internal combustion engines, usually diesel engines.

Government regulations have recently required the use of devices to treat engine exhaust gas (hereinafter after-treatment devices or ATDs) to remove residual pollutants from the raw exhaust gas. These devices can be remotely mounted from the engine to treat the exhaust gas. The ATDs have a very high surface temperature when they undergo periodic regeneration. These high temperatures at the outer surface of the devices can cause dust or other plant matter that collects on the outer surface to combust.

One way of preventing this combustion is to keep the surface of the ATD clean. This can be achieved by directing a portion of the air moved by the radiator cooling fan across the upper surface of the ATD. An example of this arrangement can be seen in US 2010/0275587 A1.

A drawback to these and similar designs is that the air used for cleaning the surface of the ATD contains dust and other plant matter. The air directed across the surface of the ATD by these prior designs must scour the surface at a high velocity in order to prevent the dust mixed with the air from settling on the surface of the ATD and permitting a layer of dust to build up.

Furthermore, if the ATD is placed remotely from the engine, a rather long conduit must be provided to conduct air from the cooling air fan to the ATD.

What is needed is an arrangement for keeping the ATD clean of dust and other particulate matter using a source of clean air or gas that avoids the expense of using a conduit and that does not rob some of the power from the cooling fan.

It is an object of this invention to provide such an arrangement.

### SUMMARY OF THE INVENTION

In accordance with a first aspect of the invention, an ATD has a shield that substantially encloses the outer surface of the ATD. This shield is coupled to the exhaust gas outlet of the ATD. At least a portion of the treated exhaust gas (i.e. the exhaust gas leaving the ATD) is conducted into the space between the outer surface of the ATD and the shield. Various structures (described in more detail below) conduct at least a portion of the treated exhaust gas into the space defined between the shield and the ATD at a higher pressure than the surrounding atmosphere and therefore slightly pressurizes the space. The slightly pressurized treated exhaust gas displaces the lower pressure ambient air that contains suspended dust and combustible particulates. The treated exhaust gas has almost no suspended combustible matter or dust since it has already been combusted in the internal combustion engine and has further passed through the ATD element. This arrangement prevents or significantly reduces the dust and combustible particulate matter entrained in the surrounding atmosphere from settling and accumulating on the outer surface of the ATD.

All the exhaust gas exiting the ATD can be communicated into the space between the shield and he ATD. Alternatively, only a portion of the gas may be communicated into the space, leaving the remainder (and preferably the majority) of the exhaust gas to continue out an exhaust pipe that is coupled to and extends from the exhaust gas outlet of the ATD.

A venturi or other structure may be located in an exhaust gas line extending from the outlet of the ATD to the space between the shield and the ATD to entrain air from the atmosphere surrounding the ATD. This arrangement preferably uses the kinetic energy of the exhaust gas to entrain atmospheric air with the exhaust gas diverted into the space. The outlet of this venturi or other structure may then be conducted through a conduit to the space between the shield and the ATD to thereby insert this combines exhaust and air mixture into the space between the shield and the ATD.

### BRIEF DESCRIPTION OF THE DRAWINGS

FIG. 1 is a schematic diagram of a prior art arrangement of an internal combustion engine with an ATD and an exhaust stack or muffler.

FIGS. 2-5 are schematic diagrams of the arrangement of FIG. 1 with an ATD in accordance with the present invention in place of the ATD illustrated in FIG. 1.

### DETAILED DESCRIPTION OF THE INVENTION

In the discussion herein, “after-treatment device” refers to any device for chemically converting or processing exhaust gas from an internal combustion engine before the release of the exhaust gas into the atmosphere, including but not limited to diesel particular filters and catalytic converters.

The term “pressure” or “pressurize” is used herein. The amount of pressure that is deemed to constitute being “pressurized” is an amount of pressure sufficient to prevent substantially all ambient air from entering and circulating freely within the shielding in quantities that permit the deposit of combustible quantities of dust or particulate matter to settle on the after-treatment device.

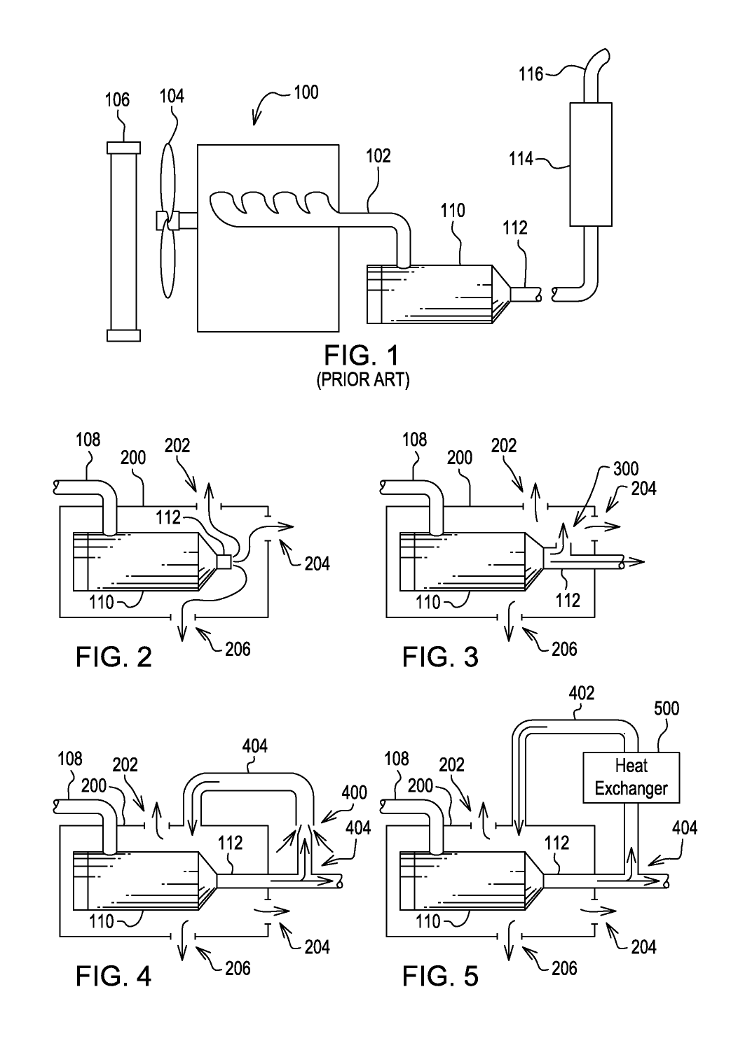

Referring now to the drawings and more particularly to FIG. 1 there is shown an internal combustion engine 100 for a work vehicle such as an agricultural vehicle. The IC engine 100 has an exhaust manifold 102 that receives exhaust gas from the cylinders of the IC engine 100. A cooling fan 104 is provided to draw air through a radiator 106 that is in fluid communication with the IC engine 100.

The exhaust manifold 102 is coupled to an exhaust gas inlet 108 of an after-treatment device (ATD) 110, which is here shown as a catalytic converter or a diesel particulate filter.

The ATD had a generally cylindrical body with a treated exhaust gas outlet 112. Outlet 112 is in fluid communication with an exhaust stack or muffler 114 which carries the exhaust gas away from the vehicle and releases it into the atmosphere through outlet 116. This arrangement of ATD with engine and exhaust stack or muffler is the intended arrangement with which the novel ATD with shield of FIGS. 2-5 is intended to be used.

FIG. 2 illustrates a first embodiment of the ATD in accordance with the present invention. In this arrangement, the ATD is enclosed with a shield 200 that extends partially or completely around the ATD at least sufficient to cover the dust-collecting upper surfaces. The preferred embodiment is disclosed in FIG. 2 in which substantially the entire ATD is surrounded by the shield 200 and in which the exhaust gas inlet 108 passes through the shield 200.

The exhaust gas outlet 112 empties into the space defined between the shield and the ATD and exists through any one or more of top aperture 202, end aperture 204, and bottom aperture 206. The flow of exhaust gas into the space creates a pressure slightly above atmospheric pressure in the space and therefore prevents dust and particulate carrying outside air from entering the shield and depositing the dust and particulates on the outer surface of ATD 110.

In this arrangement, substantially all the exhaust is communicated into the space between the ATD and the shield. This is not necessary, however, as the next figure illustrates.

In the FIG. 3 embodiment of the invention the exhaust gas outlet 112 has an aperture 300 that permits a portion of the treated exhaust gas to leave the exhaust gas outlet 112 and be communicated into the space between the shield and the ATD. The remaining volume of treated exhaust gas is conducted through the exhaust gas outlet 112 through the shield 200 and into the exhaust stack or muffler 114 (as shown in FIG. 1).

The third embodiment (FIG. 4) discloses an alternative method of communicating exhaust gas into the space between the shield and the ATD. In FIG. 4, the exhaust gas outlet 112 splits its flow path as in the embodiment of FIG. 3, but in FIG. 4 directs a portion of the exhaust gas into an external conduit 404 that includes a venturi 400. The venturi 400 uses the flow of the exhaust gas to entrain a portion of atmospheric air and conducts the mixed exhaust gas and atmospheric air through a continuing portion 402 of conduit 404 back through the shield 200 and into the space between the shield and the ATD. This arrangement serves to provide a cooler source of gas to surround the ATD. By entraining a portion of the atmospheric air surrounding the ATD into the space there is some additional dust that is introduced. However, by carefully selecting the relative size of the venturi this additional dust can be maintained below a critical level while still providing the benefits of keeping the ATD clean.

In an alternative arrangement (not shown), a conduit without the venturi can be employed to conduct at least a portion of the treated exhaust gas to a location on the outside of the shield and the space, and then to conduct it back through the shield and into the space as shown in FIGS. 4-5 but without the venturi or the heat exchanger.

The fourth embodiment (FIG. 5) shows the same arrangement of FIG. 4, but with the venturi 400 removed and replaced with a heat exchanger 500 that is configured to cool down the exhaust gas introduced into conduit 404.

Having described the preferred embodiment, it will become apparent that various modifications can be made without departing from the scope of the invention as defined in the accompanying claims.

1. An exhaust gas after-treatment device with pressurized shielding is provided, comprising:
an after-treatment device comprising a body, the body comprising an outer surface, an exhaust gas inlet formed in the body, and an exhaust gas outlet formed in the body, the body further comprising an after-treatment element for treating the exhaust gas to reduce products of incomplete combustion and through which the exhaust gas passes as the exhaust gas travels from the exhaust gas inlet to the exhaust gas outlet;
a shield comprising an inner surface and an outer surface, the shield extending around at least an upper portion of the after-treatment device and defining a space between the outer surface of the body and an inner surface of the shield; and
a means for pressurizing the space with at least a portion of exhaust gas from the exhaust gas outlet.

2. The exhaust gas after-treatment device of claim 1, wherein the means for pressurizing further comprises a means for communicating all exhaust gas from the exhaust gas outlet into the space.

3. The exhaust gas after-treatment device of claim 1, wherein the means for pressurizing further comprises a means for communicating less than all of the exhaust gas from the exhaust gas outlet into the space.

4. The exhaust gas after-treatment device of claim 1, wherein the means for pressurizing further comprises a means for communicating the exhaust gas into the space.

5. The exhaust gas after-treatment device of claim 1 wherein the means for pressurizing further comprises a means for communicating a smaller portion of the exhaust gas from the exhaust gas outlet into the space and a larger portion of the exhaust gas from the exhaust gas outlet into an exhaust pipe.

6. The exhaust gas after-treatment device of claim 1, further comprising at least one aperture extending through the shield to communicate the at least a portion of the exhaust gas out of the space.

7. The exhaust gas after-treatment device of claim 6, wherein the at least one aperture is located in an upwardly facing surface of the shield.

8. The exhaust gas after-treatment device of claim 6, wherein the at least one aperture is located in a generally horizontal facing surface of the shield.

9. The exhaust gas after-treatment device of claim 6, wherein the at least one aperture is located in a downwardly facing surface of the shield.

10. The exhaust gas after-treatment device of claim 1, wherein the means for pressurizing further comprises a means for communicating the at least a portion of the exhaust gas from the space directly from the exhaust gas outlet into the space.

11. The exhaust gas after-treatment device of claim 1, wherein the means for pressurizing further comprises a means for communicating exhaust gas to a location outside of the shield and a means for communicating exhaust gas.

12. The exhaust gas after-treatment device of claim 1 wherein the means for pressurizing further comprises a structure that uses the kinetic energy of the at least a portion of the exhaust gas for entraining outside air into the at least a portion of exhaust gas.

13. The exhaust gas after-treatment device of claim 12, wherein the structure comprises a venturi.

14. The exhaust gas after-treatment device of claim 1, wherein the means for pressurizing further comprises a heat exchanger disposed to conduct heat from the at least a portion of the exhaust gas before said at least a portion of the exhaust gas is released into the space.

15. An exhaust gas after-treatment device comprising an after-treatment element surrounded by a shield.
